(19) United States
(12) Patent Application Publication
(10) Pub. No.: US 2022/0408998 A1
(43) Pub. Date: Dec. 29, 2022

(54) MAP DATA COMMUNICATION FOR CLEANING DEVICE

(71) Applicant: Anker Innovations Technology Co. Ltd., Changsha (CN)

(72) Inventor: Jinghua Wu, Shenzhen (CN)

(21) Appl. No.: 17/848,753

(22) Filed: Jun. 24, 2022

(30) Foreign Application Priority Data
Jun. 25, 2021 (CN) 202110711712.4

(51) Int. Cl. A47L 11/40; G05D 1/02

(52) U.S. Cl. CPC A47L 11/4011; G05D 1/0274; A47L 2201/04; G05D 2201/0203

(57) ABSTRACT

The present application describes one or more map data transmission methods, cleaning devices and storage media. A method may comprise obtaining a first map data corresponding to a current cleaning position and a second map data corresponding to a previous cleaning position. Both the first and second map data may be divided into at least two map layers. The method may further comprise extracting a first map layer data from the first map data and extracting a second map layer data from the second map data. The method may further comprise obtaining the changed first map layer data with respect to the second map data of the same map layer; and sending the changed first map layer data to a computing device (e.g., a cloud server).

### CROSS REFERENCE TO RELATED APPLICATIONS

This Application claims priority to Chinese Application 202110711712.4, filed on Jun. 25, 2021. The disclosure of the prior application is incorporated herein by its entirety.

### BACKGROUND OF INVENTION

The present application relates to the technical field of cleaning devices (e.g., robots), and in particular to methods of map data transmission, cleaning devices, systems, and storage media.

A cleaning device (e.g., floor-cleaning robot, floor vacuum and/or mop device) can build a map in advance through its own sensors, and the cleaning device will keep updating the map as the location of the cleaning device changes during cleaning process, resulting in real-time changes in map data during the cleaning process. In order to facilitate users to understand the cleaning progress, the cleaning device needs to transmit the real-time changing map data to the user terminal during the cleaning process, and the user terminal renders and displays the changing map data for users to view.

However, the transmission of real-time changing map data requires a large amount of network bandwidth, and due to limited network bandwidth, each transmission of complete map data not only consumes a large amount of network bandwidth, but also the effectiveness of the transmission is poor, which cannot meet user needs.

### SUMMARY OF INVENTION

In order to solve the above technical problems, the present application describes one or more methods of map data transmission, cleaning devices, systems, and storage media.

For example, the present application describes a method of map data transmission of a cleaning device. The method comprises: obtaining a first map data corresponding to a current cleaning position and a second map data corresponding to a previous cleaning position, the first and second map data are both pre-divided into at least two map layers; extracting first map layer data from the first map data for each map layer and extracting second map data from the second map data for each map layer; obtaining the first map layer data for which the second map layer data has changed relative to the same map layer (e.g., a difference between the first map layer data and the second map layer data); sending the changed first map layer data to a computing device (e.g., a cloud server).

At least two of said map layers may comprise two of the following: a parameter layer comprising map parameters of the cleaning map, a pixel layer comprising pixel data for each pixel point in said cleaning map, a trajectory layer comprising trajectory data for the cleaning trajectory, a pose layer comprising pose data for the cleaning pose, a partitioned room layer comprising partitioned room information for the cleaning partitioned room, a restricted area layer comprising restricted area information for the cleaning restricted area, or a virtual wall layer comprising virtual wall information for the virtual wall of the map in said cleaning map and one or more of said room identifiers of said cleaning partitioned rooms.

When the first map layer data for which the second map layer data relative to the map layer has changed is the first map layer data for the pixel layer; said obtaining the first map layer data for which the second map layer data relative to the map layer of the map layer has changed may comprise: obtaining a multi-dimensional first map layer data of the pixel layer from the first map data, obtaining a multi-dimensional second map layer data of a same pixel layer from the second map data; dimensionally transforming the multi-dimensional first map layer data to obtain an one-dimensional first map layer data, and dimensionally transforming the multi-dimensional second map layer data to obtain an one-dimensional second map layer data; partitioning the one-dimensional first map layer data into a plurality of data block-sized blocks of first map data, and partitioning the one-dimensional second map layer data into a plurality of data block-sized blocks of second map data; and obtaining a first map data block that has changed relative to the second map data block of the same data block size.

Sending to the cloud said first map layer data that has changed may comprise: obtaining a first encoding method used in the last sending of the first map layer data; obtaining a second encoding method different from the first encoding method; encoding the first map layer data using the second encoding method; and sending the first map layer data encoded by the second encoding method to the cloud. The first map layer data may comprise: a map identification, a map layer identification, a data type, a data offset, and/or a data length.

The present application also describes a method of map data transmission applied to the cloud. The method comprises: receiving a first map layer data sent by a cleaning device, the first map layer data is changed relative to a second map layer data of a same map layer, the first map layer data is obtained by map layer extraction of the first map data corresponding to a current cleaning position of the cleaning device, the second map layer data is obtained by map layer extraction of the second map data corresponding to a previous cleaning position of the cleaning device, the first map data and the second map data are both pre-divided into at least two map layers; determining whether a third map data exists in the cloud and whether a third map layer data corresponding to the first map layer data exists in the third map data; when the third map data exists in the cloud and the third map layer data exists in the third map data corresponding to the first map layer data, updating the third map layer data in the third map data to the first map layer data.

In the third map data of the cloud, determining whether the third map data exists in the cloud and whether the third map data corresponding to the first map layer data exists in the third map data comprises: extracting map identification and map layer identification in the first map layer data; determining whether the third map data corresponding to the map identification exists in the cloud; when the third map data corresponding to the map layer identification exists in the cloud, determining whether a third map layer data corresponding to the map layer identification exists in the third map data; when the third map layer data corresponding to the map layer identification exists in the third map data, determining that the third map layer data exists in the cloud and the third map layer data corresponding to the first map layer data exists in the third map data.

The method further comprises: when the third map layer data corresponding to the first map layer data does not exist in the third map data, creating a third map layer data corresponding to the first map layer data; and updating the third map layer data in the third map data as the first map layer data.

The method further comprises: creating the third map data when the third map data does not exist in the cloud; creating a third map layer data corresponding to the first map layer data in the third map data; and updating the third map layer data in the third map data as the first map layer data.

Updating the third map layer data in the third map data to the first map layer data comprises: extracting the data type, data offset position, data length and data content in the first map layer data; when the data type is add/insert, adding/inserting data content of the data length to the data offset position of the third map layer data.

Updating the third map layer data in the third map data to the first map layer data when the third map data exists in the cloud and the third map data exists in the third map data corresponding to the first map layer data comprises: extracting the data type, data offset position, data length and data content in the first map layer data; deleting at least some of said third map layer data when said data type is deleted; shifting said data content at said data offset position by a distance of said data length when said data type is insertion, and inserting said data content of said data length at said data offset position in said third map layer data. Inserting data content of said data length at said data offset location in said third map layer data when said data type is increase.

If the first map layer data that has changed relative to the second map layer data of the same the map layer is the first map layer data of the pixel layer, updating the third map layer data of the third map data to said first map layer data comprises: obtaining a first decoding method for decoding the last received first map layer data; obtaining a second decoding method different from the first decoding method; decoding the first map layer data using the second decoding method to obtain the decoded first map layer data; dimensionally transforming of the decoded first map layer data to obtain first multi-dimensional map data; and updating the third map layer data using the first multi-dimensional map data.

The present application also provides a method of map data transmission applied to a user terminal, the method comprises: receiving first map layer data sent from the cloud, the first map layer data is sent by the cloud after updating the second map layer data to the first map layer data, the first map layer data is changed relative to the second map layer data of the same map layer, the first map layer data is obtained by map layer extraction of the first map data corresponding to the current cleaning position of the cleaning device, the second map layer data is obtained by map layer extraction of the second map data corresponding to the previous cleaning position of the cleaning device, the first and second map data are both pre-divided into at least two map layers; determining whether a fourth map data exists in the user terminal and whether there is a fourth map layer data corresponding to the first map layer data in the fourth map data; updating the fourth map layer data in the fourth map data to the first map layer data when the fourth map data exists in the user terminal and the fourth map data corresponds to the first map layer data; and rendering the updated fourth map data.

The present application also describes a cleaning device comprising one or more processors, communication interfaces, memory, and communication interfaces, wherein the processors, the communication interfaces, and the memory may communication with each other via one of the communication interfaces. The processors may be used for performing the map data transmission methods described herein.

The present application also provides a non-transitory computer readable storage medium storing instructions and/or programs used for performing the map data transmission methods described herein.

The above technical solutions provided by this application have at least the following advantages over the prior art.

Firstly, a cleaning device obtains the first map data corresponding to the current cleaning position and the second map data corresponding to the previous cleaning position by first obtaining the first map data and the second map data, wherein the first map data and said second map data are pre-divided into at least two map layers, and then extracting the first map layer data of each map layer in said first map data and the second map layer data of each said map layer in said second map data. Then the first map layer data which has changed relative to the second map layer data of the same map layer is obtained, and finally the first map layer data which has changed can be sent to the cloud.

Secondly, by sending to the cloud only the first map layer data that has changed relative to the second map layer data of the same map layer, the cleaning device transfers less data, reduces the bandwidth resources occupied by the transmission of map data, and avoids the transmission delay of map data.

Thirdly, the cleaning device enables stitching of map data by receiving the first map layer data sent by the cleaning device that changes relative to the second map layer data of the same map layer, using the first map layer data to update the third map layer data in the cloud, as well as enabling saving the complete map data in the cloud, which can make the transmission of map data less compared to transmitting all the map data, reducing the bandwidth resources occupied by the transmission of map data and avoid the delay of map data transmission.

Last but not least, the cleaning device, by receiving the first map layer data sent from the cloud that changes relative to the second map layer data of the same map layer, uses the first map layer data to update the fourth map layer data local to the user terminal, realizes the stitching of map data in the user terminal, and realizes the rendering of complete map data in the user terminal, which, relative to the transmission of all map data, can reduce the transmission volume (e.g., size of transmission packets/data), the bandwidth resources occupied by the transmission of map data, and the transmission delay of map data.

### BRIEF DESCRIPTION OF DRAWINGS

The accompanying drawings are used to provide further understanding of the embodiments of this application and form part of the specification and, together with the embodiments of this application, are used to explain this application and do not constitute a limitation of this application. In the accompanying drawings, same reference marks usually represent same parts or steps.

FIG. 1 is a flowchart of a method for map data transmission.

FIG. 2 is a schematic diagram of a first map data or a second map data.

FIG. 3 is a schematic diagram of a pixel layer.

FIG. 4 is a schematic diagram of a trajectory layer.

FIG. 5 is a schematic diagram of an attitude layer .

FIG. 6 is a schematic diagram of a partitioned room information.

FIG. 7 is a schematic diagram of an exclusion zone message.

FIG. 8 is a schematic diagram of a virtual wall message.

FIG. 9 is a schematic diagram of a partitioned room identification.

FIG. 10 is a schematic diagram of a segmentation of one-dimensional map data.

FIG. 11 is a flowchart of a method of map data transmission.

FIG. 12 is a flowchart of a method of map data transmission.

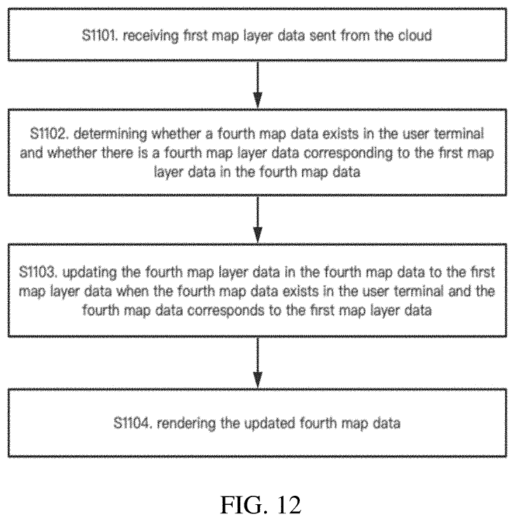

FIG. 13 is a schematic diagram of the relationship between a first map, a second map, a third map and a fourth map.

FIG. 14 is a structural diagram of a cleaning device.

### DETAILED DESCRIPTION

In order to make the object, technical solutions and advantages of the present application more apparent, the following exemplary embodiments according to the present application will be described in detail with reference to the accompanying drawings. It is clear that the described embodiments are only a portion of the embodiments of the present application and not all of the embodiments of the present application, and it should be understood that the present application is not limited by the example embodiments described herein. Based on the embodiments of this application described in this application, all other embodiments obtained by a person skilled in the art without creative labor shall fall within the scope of protection of this application.

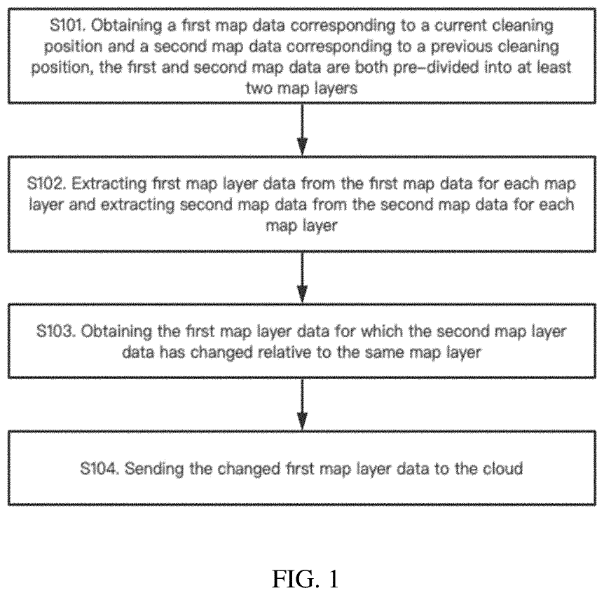

As shown in FIG. 1, a method of map data transmission that can be applied in a cleaning device (e.g., a robot) may comprise the following steps:

At Step S101, a cleaning device may obtain the first map data corresponding to the current cleaning position of the computing device and the second map data corresponding to the previous cleaning position.

The current cleaning position refers to the current cleaning moment where the cleaning device is located, the previous cleaning position refers to the previous cleaning moment where the cleaning device is located, and the time interval between the current cleaning moment and the previous cleaning moment can be set according to the actual application needs, such as 1 second, 3 seconds or 10 seconds, etc.

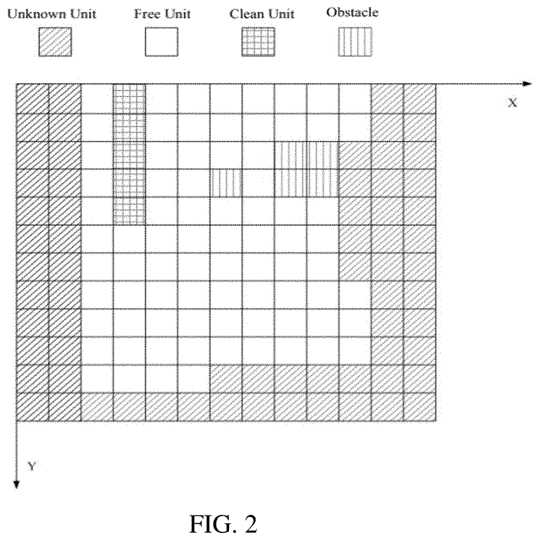

The first map data is the map data constructed by the cleaning device at the current cleaning position, and the second map data is the map data constructed by the cleaning device at the upward moving cleaning position, and each time the cleaning device can store the constructed map data into the storage record for subsequent use after constructing the map data, as shown in FIG. 2. The unknown unit in the first map data or the second map data indicates the unscanned area/location. The unknown unit in the first map data or the second map data indicates the area that has not been scanned, the free unit indicates the area that can be cleaned freely, the clean unit indicates the area that has been cleaned, and the obstacle indicates the area that cannot be cleaned.

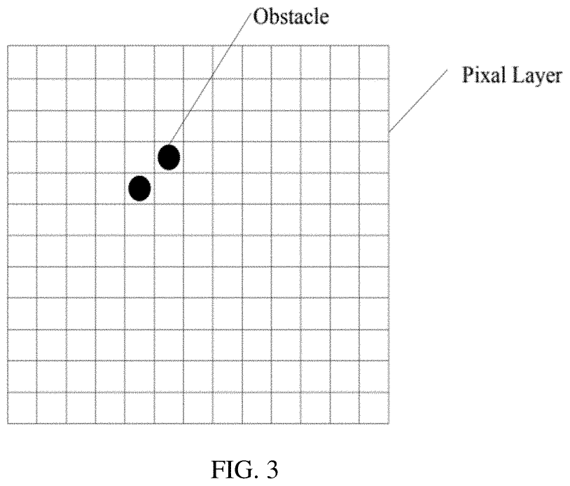

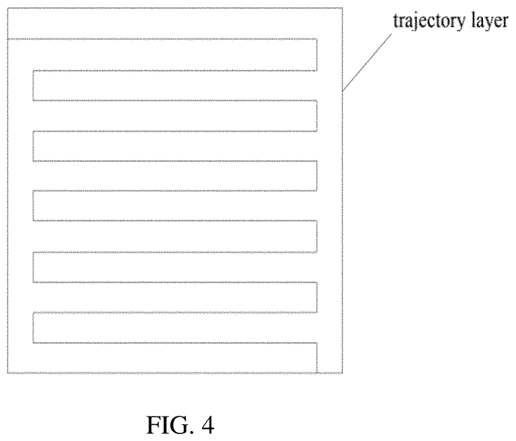

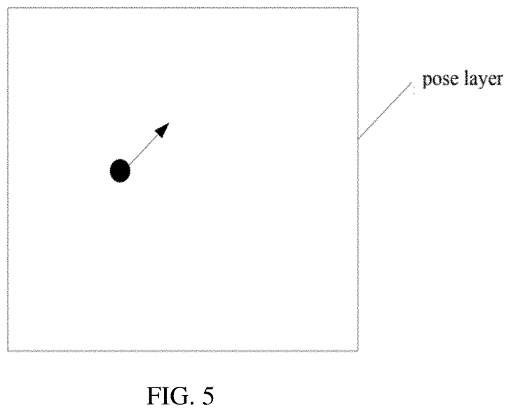

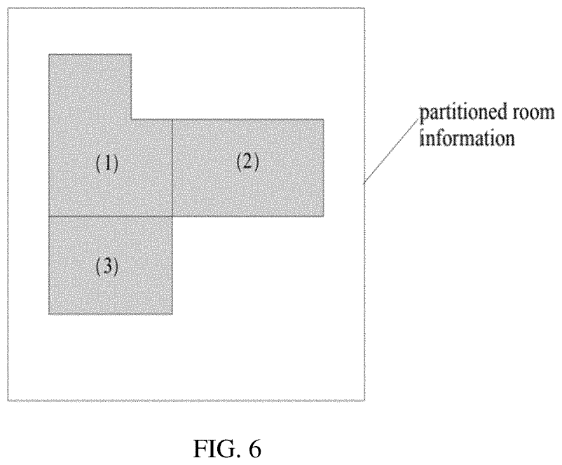

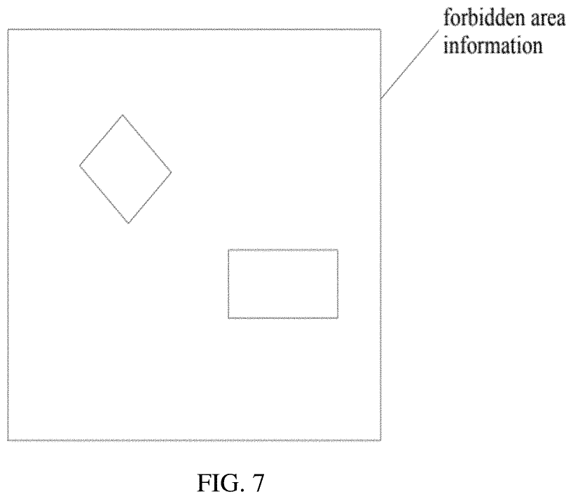

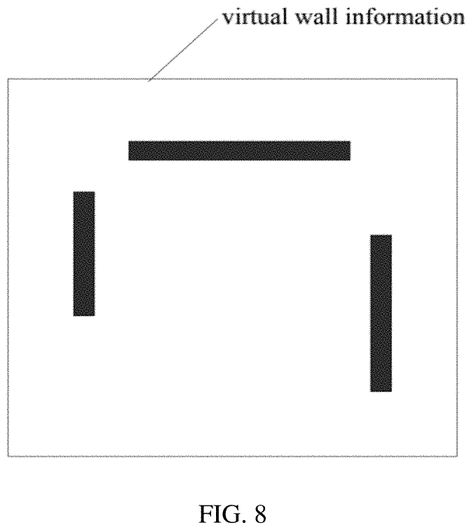

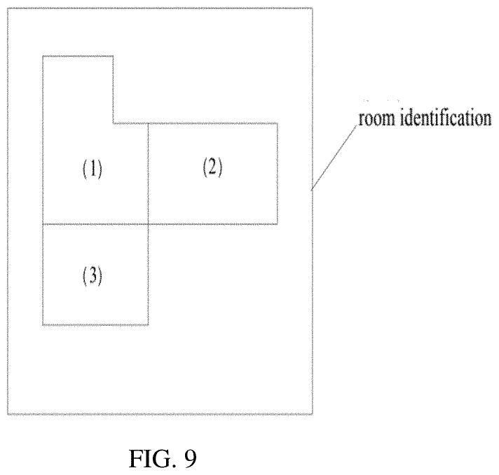

The first map data and the second map data may be divided into at least two map layers, the at least two map layers comprising: a parameter layer comprising map parameters of the cleaning map, a pixel layer comprising pixel data of each pixel point in said cleaning map (pixel data as shown in FIG. 3), a trajectory layer comprising trajectory data of the cleaning trajectory (e.g., cleaning trajectory as shown in FIG. 4), a pose layer comprising pose data of the cleaning pose (e.g., pose data as shown in FIG. 5), one or more of partitioned room information for cleaning partitioned rooms (e.g., partitioned rooms as shown in FIG. 6), a forbidden area layer comprising forbidden area information for cleaning forbidden areas (e.g., forbidden areas as shown in FIG. 7), a virtual wall layer comprising virtual wall information for map virtual walls in said cleaning map (e.g., map virtual walls as shown in FIG. 8) and room identification for said cleaning partitioned rooms (e.g., room identification as shown in FIG. 9). For example, the individual map layers are identified by numbers: e.g., parameter layer: 0, pixel layer: 0˜64, track layer: 100, partitioned room: 101, restricted area: 102, map virtual wall: 103, pose layer: 104, map room name: 105, etc.

The map layer data of each map layer may comprise data header and map layer data. The data header includes: map identifier, map layer identifier, data type, data offset and data length, etc. The map identifier is used to distinguish different map data, each map layer identifier is used to distinguish different map layer data, the data type is used to identify whether the current data is add type, delete type, or insert type, etc., for example. Delete type is used to indicate that some or all data of the current map layer is cleared, Add type is used to indicate that the data is filled according to the offset position and the data length is the length of the data content, and Insert type is used to indicate that the data at the offset position is moved according to the distance of the data offset and the current data is filled at the blank position after the data is moved. The data offset is the position where the data is stored and the cloud may select the storage position according to the data The cloud may select the storage location based on the data offset.

The data headers for the first map layer data and the second map layer data accordingly include information such as: map identification, map layer identification, data type, data offset, and data length.

In this step, the first map data can be obtained directly after the cleaning device has constructed a map based on the current cleaning location, and the second map data corresponding to the previous cleaning location can be obtained within the stored record of the map data.

At Step S102, the cleaning device may extract, in the first map data, the first map layer data for each map layer and in the second map data the second map layer data for each map layer.

The cleaning device may extract the first map layer data corresponding to each map layer in the first map data and the second map layer data corresponding to each map layer in the second map data in this step because at least two map layers are divided in advance for the first map data and the second map data.

At Step S103, the cleaning device may obtain the first map layer data for which the second map layer data has changed relative to the second map layer of the same map layer.

In this step, for any map layer, the first map layer data of that map layer can be compared with the second map layer data, and if the first map layer data is different from the second map layer data, it can be determined that the first map layer data has changed relative to the second map layer data, and that first map layer data (e.g., data difference) is obtained.

If there exists a plurality of map layers whose first map layer data changes with respect to the second map layer data of the same map layer, the first map layer data of the plurality of map layers can be obtained.

At Step S104, the cleaning device may send the changed first map layer data to the cloud.

The data format of each map layer data can be defined according to the data characteristics of each map layer data. The data with few changes and small amount of data can be directly transmitted in full amount (e.g., all data transmission), such as: parameter layer and attitude layer, etc., the data of each change is not related to the data of the last change can be transmitted in incremental amount (e.g., only the change is transmitted), such as: trajectory layer. If the data is related to the last change, the data may be transmitted in full+differential (see below for an example of transmitting the data of the first map layer corresponding to the pixel layer), e.g., the pixel layer, etc.

Firstly, the computing device may obtain the first map data corresponding to the current cleaning position and the second map data corresponding to the previous cleaning position by first obtaining the first map data and the second map data, wherein the first map data and said second map data are pre-divided into at least two map layers, and then extracting the first map layer data of each map layer in said first map data and the second map layer data of each said map layer in said second map data. Then the first map layer data which has changed relative to the second map layer data of the same map layer is obtained, and finally the first map layer data which has changed can be sent to the cloud.

Secondly, by sending to the cloud only the first map layer data that has changed relative to the second map layer data of the same map layer, the cleaning device may transfer less data, reduce the bandwidth resources occupied by the transmission of map data, and avoid or reduce the transmission delay of map data.

In the field of sweeper devices, the device may build a map through its own sensors, and the device may keep updating the map as it cleans, with map pixel cells. The map pixel cells are divided into free areas, obstacle areas, unknown areas, and/or cleaned areas, etc. The existing map update method requires the whole map data to be packaged and transmitted, if the map update is too frequent, the whole map needs to be updated and transmitted frequently. The map data volume is large, which requires a larger network bandwidth of the device and the transmission time will be extended correspondingly. To this end, the present application describes that when the first map layer data that changes relative to the second map layer data of the same map layer is the first map layer data of the pixel layer, the complete map data can be divided into fixed size partitions, divided into fixed size blocks, and the map is updated by transmitting only the blocks with data changes. As the map data of each piece becomes smaller, the differential comparison of the changed data is carried out for differential transmission, so that the map is transmitted in an incremental-like manner, and only the part of the updated map that has changed is transmitted, thus significantly reducing the size of the transmission of map data.

At step 103, the cleaning device may obtain first map layer data for which the second map layer data has changed relative to the second map layer of the same map layer comprises:

At Step 201, the cleaning device may obtain multi-dimensional first map layer data of the pixel layer in the first map data and multi-dimensional second map layer data of the same pixel layer in the second map data.

The map layer data of the pixel layer may comprise complete raster map data, and the map layer data may comprise two-dimensional map data with a map size of w*h, wherein w is the width of the map and h is the height of the map.

Since the first map layer data of each map layer has been extracted in the first map data and the second map layer data of each the map layer has been extracted in the second map data in step S102, the first map layer data and the second map layer data of the pixel layer can be obtained in this step, and both the first map layer data and the second map layer data may be multi-dimensional.

At Step 202, the cleaning device may transform the multi-dimensional first map layer data to obtain one-dimensional first map layer data and transform said multi-dimensional second map layer data to obtain one-dimensional second map layer data.

The map layer data can be divided into, for example, free areas, obstacle areas, unknown areas, and/or cleaned areas, etc., and each pixel unit can be located in a free area, an obstacle area, an unknown area, or a cleaned area.

Using P(x, y)=s as the pixel cell in the multidimensional map layer data, w as the width of the map, h as the height of the map, x in the range 0≤x<w, y in the range 0≤y<h, and the size of all pixels of the map as size(P)=w*h, the multi-dimensional map layer data can be transformed into one-dimensional map layer data as follows:

P(x, y)⇒R(i).

Where, i=x*w+y, i denotes the smallest unit in the one-dimensional map layer data, and multiple smallest units i make up the one-dimensional map layer data.

At Step 203, the cleaning device may partition the one-dimensional first map layer data into a plurality of data block-sized blocks of first map data and the one-dimensional second map layer data into a plurality of data block-sized blocks of second map data.

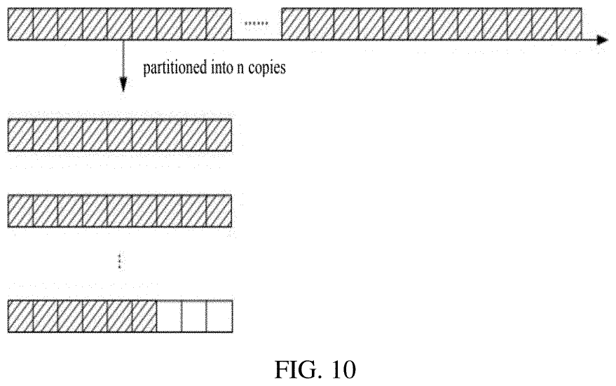

As shown in FIG. 10, the data block size can be predefined as N. The one-dimensional map layer data can be partitioned into n copies according to the following equation, and n can be calculated according to the following equation:

n=(size(P)+N)/N

Each map data block obtained by partitioning can be denoted as B(b, k), where b denotes the map data block number and k denotes the map data block size, to partition the one-dimensional map layer data into multiple map data blocks of data block size.

### 1. R(i)=⇒B(b, k)

2. R(i)=B(i/N, i%N)

The range of values of b: 0≤b<n, and the range of values of k: 0≤k<(size(P)+N) % N.

The size of the map data block can be 8*8, 16*16, 32*32, 64*64 or other fixed sizes, depending on the maximum resolution of the map.

At Step 204, the cleaning device may obtain a first map data block that has changed relative to the second map data block of the same data block size.

The first map data block in the map layer data of the pixel layer that changes relative to the second map data block of the same map block size can be obtained, and this first map data block is used as the first map layer data of the pixel layer. The cleaning device may transmit only the block with data changes when the map is updated by performing a fixed size segmentation of the complete map data and segmenting it into fixed size blocks. As each block of map data becomes smaller, differential comparison of the changed data is performed for differential transmission, so that the map is transmitted in a similar incremental manner, and only the part of the updated map change is transmitted, thereby substantially reducing the transmission of map data.

In an example, the cleaning device may send the first map layer data that has changed to a different computing device (e.g., a cloud server). The sending step may comprises the following step(s).

At Step 301, the cleaning device may obtain the first encoding method used in the last sending of the first map layer data.

The cleaning device may record the first encoding method used for the first map layer data each time the first map layer data is sent to the cloud, and the first encoding method may refer to the full data encoding method or the differential data encoding method.

If this is the first time the first map layer data is sent to the cloud, the full data encoding method can be determined as the first encoding method, and if this is not the first time the first map layer data is sent to the cloud, the first encoding method used in the last recorded sending of the first map layer data can be obtained.

At Step 302, the cleaning device may obtain a second encoding method different from the first encoding method.

A number of encoding methods for encoding the first map layer data can be set in advance, and when a second encoding method different from the first encoding method is needed, an encoding method other than the first encoding method is found among the number of encoding methods, and the found encoding method is determined as the second encoding method.

The full data encoding method (BP) and the differential data encoding method (DP) can be predefined, assuming that the first encoding method used last time is BP, then the second encoding method is DP, and if the first encoding method used last time is DP, then the second encoding method is BP, so that the BP+DP+BP+DP transmission mechanism may be implemented.

At Step 303, the cleaning device may encode the first map layer data obtained using the second encoding method.

Embodiments of the present application may encode the first map layer data in the following manner.

Data packing method may comprise: map data block number b+message type+full data/differential data.

The message type may be: divided into full/differential. The data content is encoded in a second encoding method for full or differential data, such as full data available in a segmented compression method.

At Step 304, the cleaning device may send the first map layer data encoded by the second encoding method to the cloud.

The embodiment of the present application is able to encode the first map layer data in a second encoding way, which is different from the first encoding way used for the last transmission of the first map layer data, and different encoding ways are used for two adjacent transmissions of the first map layer data, which can facilitate that the first map layer data sent in adjacent times can be referred to each other, and when the map data changes, only the corresponding map data block is updated and transmitted part, the unchanged map data block is not transmitted, and the two adjacent changes in the segmentation unit data change less, only the corresponding differential packet is transmitted, reducing one full transmission and reducing the flow of map data transmission.

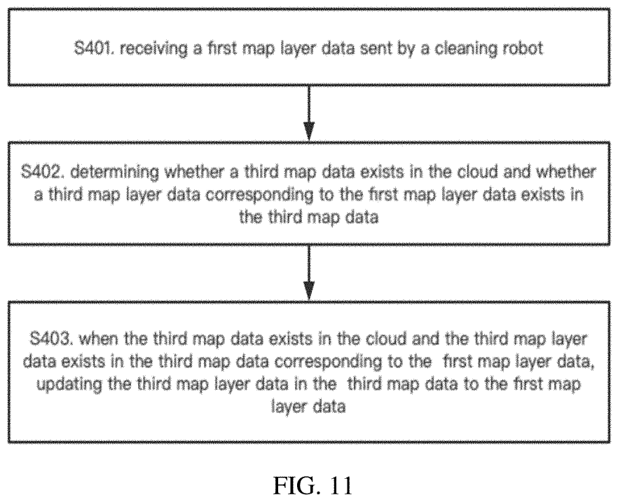

Another method of map data transmission associated with a computing device (e.g., a cloud server) is described in connection with FIG. 11. The method may comprise the following step(s).

At Step S401, the cleaning device may receive the first map layer data sent by the cleaning device.

The first map layer data is changed relative to the second map layer data of the same map layer, the first map layer data is obtained by map layer extraction of the first map data corresponding to the current cleaning position of said cleaning device, the second map layer data is obtained by map layer extraction of the second map data corresponding to the previous cleaning position of the cleaning device, the first map data and the second map data are both pre-divided into at least two map layers.

At Step S402, the cleaning device may determine whether the third map data exists in the cloud and whether the third map data corresponding to the first map layer data exists in the third map data.

The third map layer data may be the last map data received from the cleaning device, and the data content of the third map layer data may be the same as the second map layer data.

At Step S403, the cleaning device may update the third map layer data in the third map data to the first map layer data when the third map data exists in the cloud and the third map data exists in the third map data corresponding to the first map layer data.

The third map layer data in the third map data can be replaced using the first map layer data, i.e., the original third map layer data is deleted and the first map layer data is retained to realize the update of the map layer data.

By receiving the first map layer data sent by the cleaning device that changes relative to the second map layer data of the same map layer, the present invention describes using the first map layer data to update the third map layer data in the cloud to realize the stitching of map data as well as to save the complete map data in the cloud, which can reduce the size of the map data for transmission compared to the transmission of all map data. The bandwidth resources occupied by the map data are reduced, and the delay of map data transmission is avoided.

Determining whether third map data exists in the cloud and whether third map layer data corresponding to the first map layer data exists in the third map data may comprise the following step(s).

At Step 501, a computing device (e.g., a cloud device) may extract a map identity and a map layer identity in the first map layer data.

The computing device may find the third map data corresponding to the map identification in the cloud.

At Step 502, the computing device may determine whether the third map data corresponding to the map identification exists in the cloud.

At Step 503, the computing device may determine whether third map layer data corresponding to the map identification exists in the third map data when the third map data corresponding to the map layer identification exists in the cloud.

At Step 504, the computing device may determine that third map data exists in the cloud and that third map layer data corresponding to the first map layer data exists in the third map data when the third map data exists corresponding to the map layer identification.

Since the first map layer data carries the map identification and the map layer identification, the present invention can determine the corresponding third map data in the cloud based on the map identification and the corresponding third map layer data in the third map data, which can facilitate the update of the map layer data.

Finding, among the third map data in the cloud, the third map layer data corresponding to the first map layer data, may further comprise the following step(s).

At Step 601, the computing device may create a third map layer data corresponding to the first map layer data when the third map data exists in the cloud and the third map data does not exist in the third map data.

At Step 602, the computing device may update the third map layer data in the third map data to the first map layer data.

The present invention describes creating the third map layer data corresponding to the first map layer data when the third map layer data corresponding to the map layer identification does not exist in the cloud, so that the third map layer data corresponding to the first map layer data will exist in the cloud and the update of the map layer data can be easily realized.

Finding, among the third map data in the cloud, the third map layer data corresponding to the first map layer data, may comprise the following step(s).

At Step 701, the computing device may create the third map data when the third map data does not exist in the cloud.

At Step 702, the computing device may create in the third map data a third map layer data corresponding to the first map layer data.

At Step 703, the computing device may update the third map layer data in the third map data to the first map layer data.

The present invention describes creating the third map data corresponding to the map logo and the third map layer data corresponding to the first map layer data when the third map data corresponding to the map logo does not exist in the cloud, so that the map data corresponding to the map logo and the third map layer data corresponding to the first map layer data will exist in the cloud, and the update of the map layer data can be easily realized.

In an embodiment of the present invention, updating the third map layer data in the third map data to said first map layer data when the third map data exists in the cloud and the third map data does not exist in the third map data corresponding to the first map layer data, or, when the third map data does not exist in the cloud, updating the third map layer data in the third map data to the first map layer data, may comprise:

At Step 801, the computing device may extract the data type, data offset position, data length, and/or data content in the first map layer data.

At Step 802, the computing device may add (e.g., insert) data content of the data length to the data offset location of the third map layer data when the data type is add/insert.

For example, adding means adding data content at the end of the third map layer data (i.e., at the data offset position), and inserting means inserting data content in the middle of the third map layer data according to the data cheap position.

Since the first map layer data carries the data type, the data offset position, the data length and the data content, and since the third map data exists in the cloud and the third map data corresponding to the first map layer data does not exist in the third map data, or, when the third map data does not exist in the cloud, when updating the third map layer data using the first map layer data, the third map layer data can be updated directly based on the first map layer data, the corresponding content in the created map layer data can be updated to realize the stitching of map data in the cloud, as well as to realize the saving of complete map data in the cloud, and the embodiment of the present invention, because only the first map layer data that has changed is transmitted, can make the transmission of map data less compared to the transmission of all map data, reduce the bandwidth resources occupied by the transmission of map data, and avoid map data transmission delay.

Updating the third map layer data in the third map data to the first map layer data when the third map data exists in said cloud and the third map data exists in the third map data corresponding to the first map layer data may comprise the following step(s).

At Step 901, the computing device may extract the data type, data offset position, data length and data content in the first map layer data.

At Step 902, the computing device may delete at least some of the third map layer data when the data type is delete. The deleted third map layer data may be some of the data or all of the data.

For example, when the data type is inserted, shifting the data content at the data offset position by a distance of the data length to insert said data content at the data offset position in the third map layer data.

Inserting data content of the data length at the data offset location in the third map layer data when the data type is increase.

For example, deletion means deleting all data contents in the third map layer data, addition means adding data contents at the end of the third map layer data (equivalent to being at the data offset position), and insertion means inserting data contents in the middle of the third map layer data according to the data offset position.

Since the first map layer data carries data type, data offset position, data length and data content, and the original third map layer data exists in the cloud, when using the first map layer data to update the third map layer data, the corresponding content in the third map layer data in the cloud can be updated directly based on the first map layer data to realize the stitching of map data in the cloud, as well as to realize the preservation of complete map data in the cloud. The present invention, since only the first map layer data that has changed is transmitted, can reduce the size of the map data packets for transmission, reduce the bandwidth resources occupied by the transmission of map data, and avoid the transmission delay of map data, compared with the transmission of all map data.

In an example, updating the third map layer data in the third map data to the first map layer data, may comprise the following step(s).

Step 1001, the computing device may obtain a first decoding method for decoding the last received first map layer data.

Step 1002, the computing device may obtain a second decoding method different from the first decoding method.

Step 1003, the computing device may decode the first map layer data using the second decoding method to obtain the decoded first map layer data.

Step 1004, the computing device may transform the decoded first map layer data to obtain first multidimensional map data.

Step 1005, the computing device may update the third map layer data using the first multi-dimensional map data.

The present application describes decoding the first map layer data in the second decoding mode, and this second decoding mode is different from the first decoding mode used for decoding the first map layer data last time, and different decoding modes are used for sending the first map layer data twice adjacent to each other, which can facilitate the first map layer data sent in adjacent times can be referred to each other. When the map data changes, only the corresponding map data blocks need to be updated and transmitted, the unchanged map data block is not transmitted, and the data changes of two adjacent change division units are small, only the corresponding differential packet is transmitted, reducing data transmission in full and reducing the flow of map data transmission.

A method of map data transmission applied to a user terminal (e.g., a user device, mobile phone) is provided as shown in FIG, 12. The method may comprise the following step(s).

At Step 1101, a user terminal may receive first map layer data sent by the cloud.

In an example, the first map layer data is sent by the cloud after updating the second map layer data to the first map layer data, the first map layer data is changed relative to the second map layer data of the same map layer, the first map layer data is obtained by map layer extraction of the first map data corresponding to the current cleaning position of the cleaning device, and the second map layer data is obtained by map layer extraction of the second map data corresponding to the previous cleaning position of the cleaning device. The first map data and the second map data may be pre-divided into at least two map layers.

At Step 1102, the user terminal may determine whether the user terminal has fourth map data and whether the fourth map data corresponding to the first map layer data is present in the fourth map data.

At Step 1103, the user terminal may update the fourth map layer data in the fourth map data to the first map layer data when the fourth map data exists in the user terminal and the fourth map data corresponds to the first map layer data.

At Step 1104, the user terminal may perform data rendering on the updated fourth map data.

By receiving the first map layer data sent from the cloud that changes relative to the second map layer data of the same map layer, the present application describes using the first map layer data to update the local fourth map layer data in the user terminal, realizing the stitching of map data in the user terminal, and realizing the rendering of complete map data in the user terminal, which can make the transmission of map data relative to the transmission of all map data. The amount of map data transmission can be reduced, the bandwidth resources occupied by the map data transmission can be reduced, and the delay of map data transmission can be avoided.

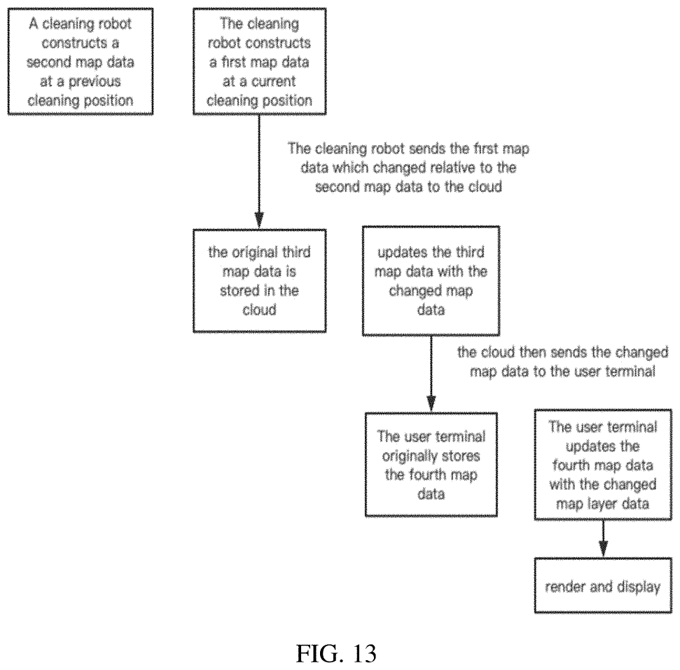

FIG. 13 illustrates a schematic diagram of a relationship between a first map, a second map, a third map, and a fourth map in a practical application. A cleaning device constructs a second map data at a previous cleaning position, constructs a first map data at a current cleaning position. When the first map data changes relative to the second map data, the cleaning device sends the first map data which changed relative to the second map data to the cloud, and the original third map data is stored in the cloud. When receiving the changed map data, the cloud updates the third map data with the changed map data, the cloud then sends the changed map data to the user terminal, which originally stores the fourth map data. When receiving the changed map layer data, the user terminal updates the fourth map data with the changed map layer data, and finally the user terminal can render and display the updated fourth map data.

The cleaning device may comprise at least one or more processors, one or more communication interfaces, one or more memory, and one or more communication buses. The processors, the communication interfaces, and the memory, may communicate with each other via the one or more communication buses. The one or more memory may be configured to storing computer programs and/or instructions for performing the methods described herein. The processors may be configured to perform the methods described herein.

The cleaning device described in the present invention can be a sweeping device, a mopping device, or an all-in-one sweeping and mopping device, without being uniquely limited herein. The processor obtains the first map data corresponding to the current cleaning position and the second map data corresponding to the previous cleaning position, wherein the first and second map data are pre-divided into at least two map layers, by first acquiring the first map data corresponding to the current cleaning position and the second map data corresponding to the previous cleaning position. Then the first map layer data of each map layer is extracted in the first map data, the second map layer data of each map layer is extracted in said second map data, then the first map layer data relative to said second map layer data of the same map layer is obtained which has changed, and finally said first map layer data which has changed can be sent to the cloud. Secondly, by sending to the cloud only the first map layer data that has changed relative to the second map layer data of the same map layer, the present application transfers less data, reduces the bandwidth resources occupied by the transmission of map data, and avoids the transmission delay of map data.

The present invention enables stitching of map data by receiving the first map layer data sent by the cleaning device that changes relative to the second map layer data of the same map layer, using the first map layer data to update the third map layer data in the cloud, as well as enabling saving the complete map data in the cloud, which, relative to transmitting all the map data, can make the transmission of map data less, reduce the bandwidth resources occupied by the transmission of map data and avoid the delay of map data transmission.

By receiving the first map layer data sent from the cloud that changes relative to the second map layer data of the same map layer, the embodiment of the present invention uses the first map layer data to update the fourth map layer data local to the user terminal, realizes the stitching of map data in the user terminal, and realizes the rendering of complete map data in the user terminal, which, relative to transmitting all map data, can make the transmission volume is reduced, the bandwidth resources occupied by the transmission of map data are reduced, and the transmission delay of map data is avoided.

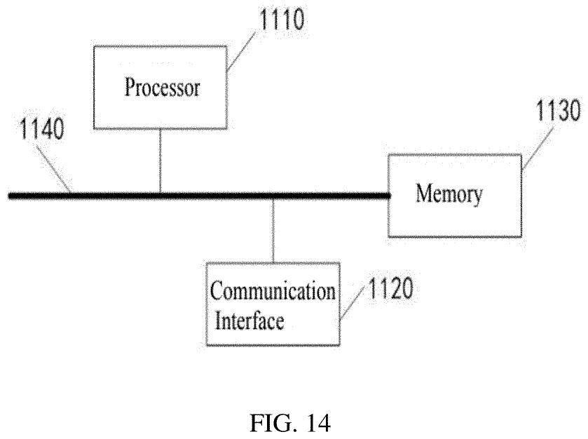

The communication bus 1140 mentioned above for cleaning devices can be a Peripheral Component Interconnect Standard (PCI) bus or an Extended Industry Standard Architecture (EISA) bus, for example. This communication bus 1140 can be divided into address bus, data bus, control bus, etc. For ease of representation, only one thick line is shown in FIG. 14, but it does not indicate that there is only one bus or one type of bus.

The communication interface 1120 is used for communication between the above cleaning device and other devices. The memory 1130 may include Random Access Memory (RAM), or it may include non-volatile memory, such as at least one disk memory. The memory may also be at least one storage device located away from the aforementioned processor. The above processor 1110 may be a general-purpose processor, including a Central Processing Unit (CPU), a Network Processor (NP), etc. It may also be a Digital Signal Processing (DSP), an Application Specific Integrated Circuit (ASIC), a Field-Programmable Gate Array (FPGA), or other programmable logic device, a discrete gate array (DGA), or a programmable logic device. Application Specific Integrated Circuit (ASIC), Field-Programmable Gate Array (FPGA), or other programmable logic devices, discrete gate or transistor logic devices, discrete hardware components.

A non-transitory computer readable storage medium is also provided, said computer readable storage medium having stored on it a program for a map data transfer method, said program for the map data transfer method when executed by a processor implementing the map data transfer method described in any of the method embodiments applied to a cleaning device, the map data transfer method described in any of the method embodiments applied to a cloud, or the steps of the map data transfer method described in the method embodiment applied to a user terminal.

It should be noted that the above embodiments illustrate the present application and do not limit it, and that a person skilled in the art may devise alternative embodiments without departing from the scope of the appended claims. Any reference symbols located between the brackets in the claim should not be constructed as a limitation of the claim. The word “comprising” does not exclude the presence of an element or step not listed in the claim. The word “one” or “one” before the component does not exclude the existence of multiple such components. This application can be implemented with the help of hardware including a number of different components and with the help of a computer appropriately programmed. In unit claims where several devices are listed, several of these devices may be specifically embodied by the same hardware item. The use of the words first, second, and third does not indicate any order. The words can be interpreted as names.

The above mentioned is only a specific implementation or a description of a specific implementation of this application. The scope of protection of this application is not limited to this, and any person skilled in the art can easily think of variations or substitutions within the technical scope disclosed in this application, which should be covered by the scope of protection of this application. The scope of protection of this application shall be subject to the scope of protection of the claims.

1. A method comprising:
obtaining, by a cleaning device, first map data corresponding to a current cleaning position and second map data corresponding to a previous cleaning position, each of the first and second map data comprises data associated with at least two map layers;
extracting first map layer data from the first map data for each of the at least two map layers and extracting second map data from the second map data for each of the at least two map layers;
for at least one of the at least two map layers, obtaining a difference between the first map layer data and the second map layer data; and
sending the difference to a computing device.

2. The method of claim 1, wherein the at least two map layers comprise at least two of the following:
a parameter layer comprising map parameters of a map,
a pixel layer comprising pixel data for each pixel point in the map,
a cleaning device track layer comprising track data for a cleaning track,
a cleaning device pose layer comprising pose data for a cleaning pose,
a partitioned room layer comprising partitioned room information for a partitioned room,
a restricted area layer comprising cleaning restricted area information for a restricted area, or
a virtual wall layer comprising one or more of virtual wall information of virtual walls in the map and room identification of said partitioned room.

3. The method of claim 11, wherein the at least one of the at least two map layers is a pixel layer comprising pixel data for each pixel point in a map, and the obtaining comprises:
obtaining multi-dimensional first map layer data of the pixel layer from the first map data, and obtaining multi-dimensional second map layer data of a same pixel layer from the second map data;
transforming the multi-dimensional first map layer data to obtain one-dimensional first map layer data, and transforming the multi-dimensional second map layer data to obtain one-dimensional second map layer data;
partitioning the one-dimensional first map layer data into a plurality of data blocks of the first map data, and partitioning the one-dimensional second map layer data into a plurality of data blocks of the second map data; and
obtaining a difference between one of the plurality data blocks of the first map data and a corresponding one of the plurality data blocks of the second map data.

4. The method of claim 1, wherein sending the comprises:
obtaining a first encoding method used in sending of previous map layer data;
encoding the difference using a second encoding method different from the first encoding method; and
sending the difference using the second encoding method.

5. The method of claim 1, wherein the first map layer data comprises at least one of:
a map identification,
a map layer identification,
a data type,
a data offsets, or
a data length.

6. A method comprising:
receiving, by a computing device and from a cleaning device, a difference between first map layer data and second map layer data, wherein the first map layer data is extracted from first map data that corresponds to a current cleaning position of the cleaning device, the second map layer data is extracted from second map data that corresponds to a previous cleaning position of the cleaning device, and each of the first map data and the second map data comprises data associated with at least two map layers;
determining whether third map layer data of stored third map data corresponds to the first map layer data; and
based on the determining that the third map layer data of the stored third map data corresponds to the first map layer data, updating the third map layer data to be the first map layer data.

7. The method of claim 6, wherein the determining comprises:
extracting map identification and map layer identification in the first map layer data;
determining whether the third map data corresponding to the map identification is stored in the computing device;
based on the determining that the third map data corresponding to the map layer identification is stored in the computing device, determining whether the third map layer data corresponding to the map layer identification is in the third map data; and
based on the determining that the third map layer data corresponding to the map layer identification is in the third map data, determining that the third map layer data is stored in the computing device, and that the third map layer data corresponding to the first map layer data is in the third map data.

8. The method of claim 6, further comprising:
based on determining the third map layer data corresponding to the first map layer data is not in the third map data, creating the third map layer data corresponding to the first map layer data; and
updating the third map layer data to be the first map layer data.

9. The method of claim 6, further comprising:
creating the third map data when the third map data is not stored in the computing device;
creating the third map layer data corresponding to the first map layer data in the third map data; and
updating the third map layer data in the third map data as the first map layer data.

10. The method of claim 6, wherein the updating comprises:
extracting a data type, a data offset position, a data length, and data content in the first map layer data; and
based on the data type and the data offset position, adding data content of the data length of the first map layer data to the third map layer data.

11. The method of claim 6, wherein the updating comprises:
extracting a data type, a data offset position, a data length and data content in the first map layer data; and
based on determining that the data type is delete, deleting at least some of the third map layer data.

12. The method of claim 6, wherein the updating comprises:
obtaining a first decoding method for decoding previous first map layer data;
obtaining a second decoding method different from the first decoding method;
decoding the first map layer data using the second decoding method to obtain the decoded first map layer data;
transforming the decoded first map layer data to obtain first multi-dimensional map data; and
updating the third map layer data based on the first multi-dimensional map data.

13. A method comprising:
receiving, by a user device and from a computing device, first map layer data, wherein the first map layer data is updated based on second map layer, the first map layer data is extracted from first map data corresponding to a current cleaning position of a cleaning device, the second map layer data is extracted from second map data corresponding to a previous cleaning position of the cleaning device, each of the first map data and second map data comprises data associated with at least two map layers;
determining that fourth map data is stored in the user device and that fourth map layer data of the fourth map data corresponds to the first map layer data;
updating the fourth map layer data in the fourth map data to the first map layer data; and
outputting the updated fourth map data.

14-15 (canceled)

16. The method of claim 1, wherein the computing device is a cloud server.

17. The method of claim 6, wherein the at least two map layers comprise two of the following:
a parameter layer comprising map parameters of a map,
a pixel layer comprising pixel data for each pixel point in the map,
a cleaning device track layer comprising track data for a cleaning track,
a cleaning device pose layer comprising pose data for a cleaning pose,
a partitioned room layer comprising partitioned room information for a partitioned room,
a restricted area layer comprising cleaning restricted area information for a restricted area, or
a virtual wall layer comprising one or more of virtual wall information of virtual walls in the map and room identification of said partitioned room.

18. The method of claim 6, wherein the first map layer data comprises at least one of:
a map identification,
a map layer identification,
a data type,
a data offset, or
a data length.

19. The method of claim 6, wherein the computing device is a cloud server.

20. The method of claim 16, wherein the computing device is a cloud server.

21. The method of claim 16, wherein the at least two map layers comprise two of the following:
a parameter layer comprising map parameters of a map,
a pixel layer comprising pixel data for each pixel point in the map,
a cleaning device track layer comprising track data for a cleaning track,
a cleaning device pose layer comprising pose data for a cleaning pose,
a partitioned room layer comprising partitioned room information for a partitioned room,
a restricted area layer comprising cleaning restricted area information for a restricted area, or
a virtual wall layer comprising one or more of virtual wall information of virtual walls in the map and room identification of said partitioned room.

22. The method of claim 16, wherein the first map layer data comprises at least one of:
a map identification,
a map layer identification,
a data type,
a data offset, or
a data length.
